(19) United States
(12) Patent Application Publication
(10) Pub. No.: US 2010/0044421 A1
(43) Pub. Date: Feb. 25, 2010

(54) PACKAGE FOR CONTAINERS

(76) Inventor: Angela E. Learn, Gilbertsville, PA (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/543,620

(22) Filed: Aug. 19, 2009

Related U.S. Application Data
(60) Provisional application No. 61/090,755, filed on Aug. 21, 2008.

(51) Int. Cl. B65D 5/42; B65D 17/32; B31B 1/26

(52) U.S. Cl. 229/121; 229/240; 493/162

(57) ABSTRACT

A carton for containing a plurality of articles. The carton has panels that extend at least partially around an interior of the carton. The panels comprise a top panel, a bottom panel, a first side panel, and a second side panel. The carton includes a dispenser for allowing access to the plurality of articles to be contained in the carton. The carton comprises an access feature for allowing restocking of the articles to be contained in the carton.

### CROSS-REFERENCE TO RELATED APPLICATION

The present application claims the benefit of Provisional Application No. 61/090,755, filed Aug. 21, 2008, the entire contents of which are hereby incorporated by reference.

### BACKGROUND OF THE DISCLOSURE

The present disclosure generally relates to cartons for holding and dispensing containers or other types of articles. More specifically, the present disclosure relates to cartons having a dispenser and an access flap.

### SUMMARY OF THE DISCLOSURE

In general, one aspect of the disclosure is directed to a carton for holding a plurality of containers. The carton comprises a plurality of panels that extends at least partially around an interior of the carton. The plurality of panels comprises a front panel, a back panel, a first side panel, and a second side panel. A dispenser for allowing access to the articles to be contained in the carton comprises a dispenser panel that is at least partially defined by a tear line in the carton and is for being at least partially removed for at least further opening a dispenser opening. The tear line extends across at least a portion of at least one of the front panel and the back panel. The tear line defines at least one retaining portion in the at least one of the front panel and the back panel, wherein the at least one retaining portion is for at least partially retaining an article in the carton after the dispenser panel is removed. An access feature for allowing restocking of the articles to be contained in the carton comprises an opening in at least one of the plurality of panels.

In another aspect, the disclosure is generally directed to a carton blank for forming a carton. The carton blank comprises a plurality of panels comprising a front panel, a back panel, a first side panel, and a second side panel. A dispenser for allowing access to a plurality of articles to be contained in the carton formed from the blank comprises a dispenser panel that is at least partially defined by a tear line in the blank and is for being at least partially removed for at least further opening a dispenser opening. The tear line extends across at least a portion of at least one of the front panel and the back panel. The tear line defines at least one retaining portion in the at least one of the front panel and the back panel, wherein the at least one retaining portion is for at least partially retaining an article in the carton formed from the blank after the dispenser panel is removed. An access feature for allowing restocking of the articles to be contained in the carton formed from the blank comprises an opening in at least one of the plurality of panels.

In another aspect the disclosure is generally directed to a method of forming a carton. The method comprises obtaining a carton blank comprising a plurality of panels comprising a front panel, a back panel, a first side panel, and a second side panel. A dispenser for allowing access to a plurality of articles to be contained in the carton formed from the blank comprises a dispenser panel that is at least partially defined by a tear line in the blank and is for being at least partially removed for at least further opening a dispenser opening. The tear line extends across at least a portion of at least one of the front panel and the back panel. The tear line defines at least one retaining portion in the at least one of the front panel and the back panel, wherein the at least one retaining portion is for at least partially retaining an article in the carton formed from the blank after the dispenser panel is removed. An access feature for allowing restocking of the articles to be contained in the carton formed from the blank comprises an opening in at least one of the plurality of panels. The method further comprises folding the panels of the plurality of panels into a carton.

Those skilled in the art will appreciate the above stated advantages and other advantages and benefits of various additional embodiments reading the following detailed description of the embodiments with reference to the below-listed drawing figures.

According to common practice, the various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

FIG. 1. is an exterior plan view of a carton blank used to form a carton in accordance with a first embodiment of the disclosure.

FIG. 2 is a perspective view showing the assembled carton.

FIG. 3 is a perspective view of the carton in an opened configuration.

FIG. 4 is a perspective view of the carton in an opened configuration.

FIG. 5 is an exterior plan view of a carton blank used to form a carton in a accordance with a second embodiment of the disclosure.

Corresponding parts are designated by corresponding reference numbers throughout the drawings.

### DETAILED DESCRIPTION OF THE EXEMPLARY EMBODIMENTS

The present disclosure generally relates to cartons that contain articles such as containers, bottles, cans, etc. The articles can be used for packaging food, beverage, and other consumer products, for example. The articles can be made from materials suitable in composition for packaging the particular food, beverage, or other consumer item, and the materials include, but are not limited to, aluminum and/or other metals; glass; plastics such as PET, LDPE, LLDPE, HDPE, PP, PS, PVC, EVOH, and Nylon; and the like, or any combination thereof.

Cartons according to the present disclosure can accommodate articles of any shape. For the purpose of illustration and not for the purpose of limiting the scope of the disclosure, the following detailed description describes consumer product containers (e.g., spray cans) as disposed within the carton embodiments. In this specification, the terms “lower,” “bottom,” “upper,” “top,” “front,” and “back” indicate orientations determined in relation to fully erected and upright cartons, and such terms are not intended to limit the scope of the disclosure.

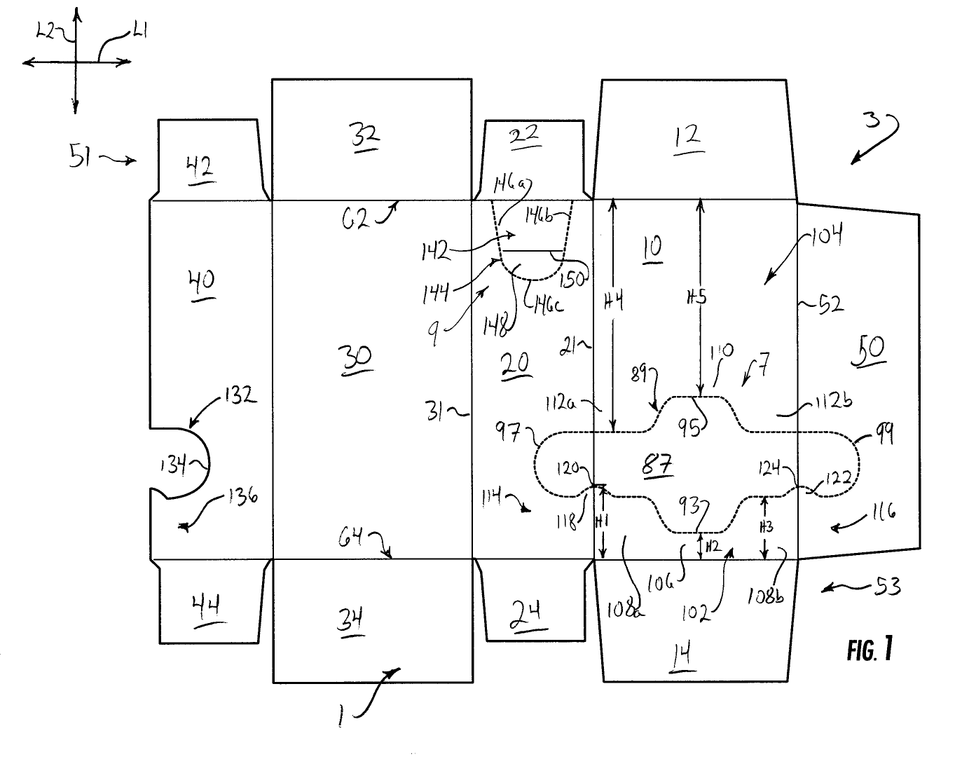

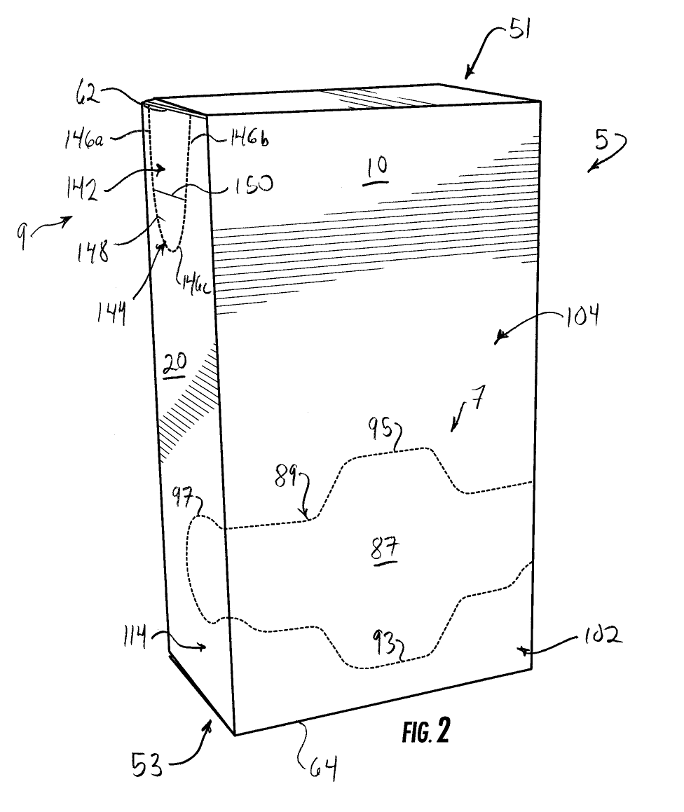

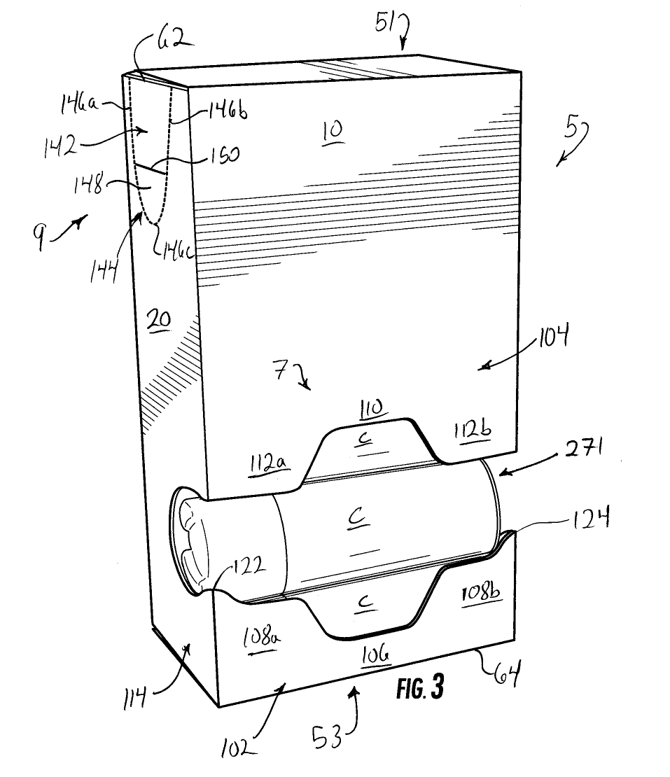

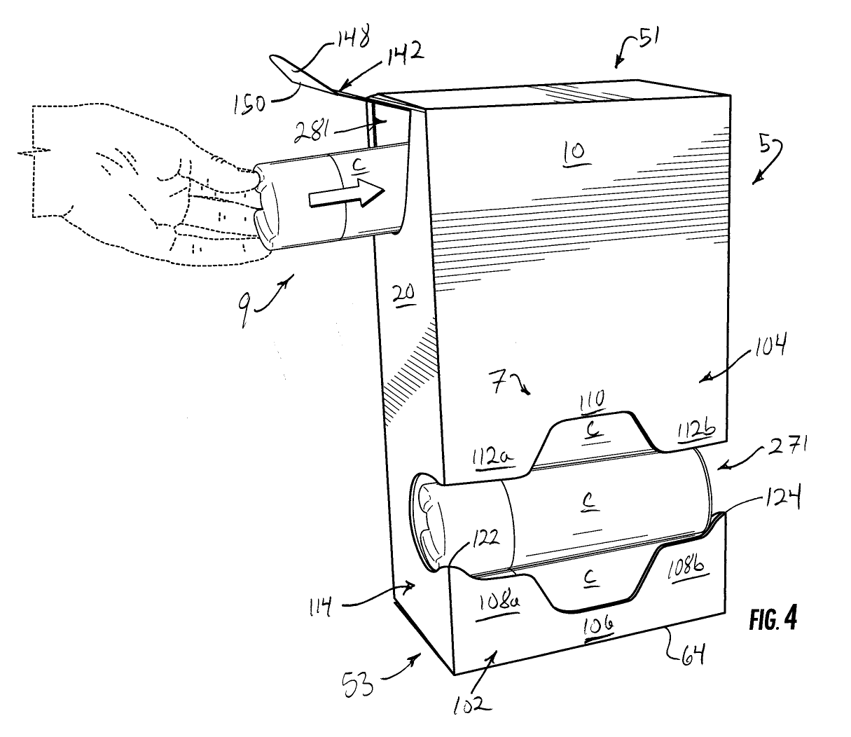

FIG. 1 is a plan view of the exterior side 1 of a blank, generally indicated at 3, used to form a carton 5 (FIGS. 2-4) according to the exemplary embodiment of the disclosure. The carton 5 can be used to house a plurality of articles such as containers C (FIGS. 3 and 4). The carton 5 has a dispenser, generally indicated at 7, formed in the carton for allowing access for dispensing the containers C and an access feature, generally indicated at 9, formed in the carton for allowing access for restocking the containers C. In the illustrated embodiment, the carton 5 is sized to house twelve containers C in a single layer in a 2×6 arrangement, but it is understood that the carton 5 may be sized and shaped to hold containers of a different or same quantity in more than one layer and/or in different row/column arrangements (e.g., 1×6, 3×6, 2×6×2, 3×4, 3×5, 2×9, 4×5, 3×4, etc.). In the illustrated embodiment, the carton 5 includes a top end 51 and a bottom end 53 (FIG. 2). As will be discussed below in more detail, the ends 51, 53 are formed from various features in the blank 3.

The carton blank 3 has a longitudinal axis L1 and a lateral axis L2. In the illustrated embodiment, the blank 3 comprises a front panel 10 foldably connected to a first side panel 20 at a first lateral fold line 21. A back panel 30 is foldably connected to the first side panel 20 at a second lateral fold line 31. A second side panel 40 is foldably connected to the back panel 30 at a third lateral fold line 41. In the illustrated embodiment, the blank 3 includes a side flap 50 foldably connected to the front panel 10 at a fourth lateral fold line 52.

The front panel 10 is foldably connected to a first front end flap 12 and a second front end flap 14. The first side panel 20 is foldably connected to a first side end flap 22 and a second side end flap 24. The back panel 30 is foldably connected to a first back end flap 32 and a second back end flap 34. The second side panel 40 is foldably connected to a first side end flap 42 and a second side end flap 44. When the carton 5 is erected, the front and back end flaps 12 and 32 and side end flaps 22, 42 close the top end 51 of the carton, and the front and back end flaps 14 and 34 and side end flaps 24, 44 close the bottom end 53 of the carton (FIG. 6). In accordance with an alternative embodiment of the present disclosure, different flap arrangements can be used for at least partially closing the ends 51, 53 of the carton 5.

The front and back end flaps 12, 32 and side end flaps 22, 42 extend along a first marginal area of the blank 3, and are foldably connected at a first longitudinal fold line 62 that extends along the length of the blank. The front and back end flaps 14, 34 and side end flaps 24, 44 extend along a second marginal area of the blank 3, and are foldably connected at a second longitudinal fold line 64 that also extends along the length of the blank. The longitudinal fold lines 62, 64 may be, for example, substantially straight, or offset at one or more locations to account for blank thickness or for other factors.

The dispenser 7 includes a dispenser panel 87 formed in the front panel 10, the first side panel 20, and the side flap 50. The dispenser panel 87 is separable from the carton 5 along a tear line, generally indicated at 89, to form a dispenser opening 271 (FIG. 3) in the carton. The dispenser 7 can include a finger panel (not shown) to allow easier opening of the dispenser. In the illustrated embodiment, the tear line 89 includes a first portion 93 and a second portion 95 in the front panel 10 that extend between the fold lines 21, 52. The tear line 89 includes a third portion 97 that extends from the first portion 93 in a generally semi-circular shape in the first side panel 20 to the second portion 95, and a fourth portion 99 that extends from the first portion 93 in a generally semi-circular shape in the side flap 50 to the second portion 95. As shown in FIG. 1, the first and second portions 93, 95 of the tear line 89 include portions extending in the longitudinal direction L1, portions that are oblique relative to the longitudinal axis L1, and curved portions. The first and second portions 93, 95, or other portions, of the tear line can be otherwise shaped, arranged, and positioned without departing from the scope of this disclosure.

The first portion 93 of the tear line 89 defines a generally U-shaped first retaining portion 102 in the front panel 10, and the second portion 95 defines a second retaining portion 104 in the front panel 10. The first retaining portion 102 includes a central portion 106 and end portions 108a, 108b, wherein the end portions 108a, 108b include a maximum height H1 of the first retaining portion 102 and the central portion 106 includes a minimum height H2 of the first retaining portion 102. The end portions 108a, 108b further include an intermediate height H3 that is between the maximum height H1 and the minimum height H2. The second retaining portion 104 includes a central portion 110 and end portions 112a, 112b, wherein the end portions 112a, 112b include a maximum height H4 of the second retaining portion 104 and the central portion 110 includes a minimum height H5 of the second retaining portion 104.

The third portion 97 of the tear line 89 defines a third retaining portion 114 in the first side panel 20, and the fourth portion 99 defines a fourth retaining portion 116 in the side flap 50. The third retaining portion 114 includes an upper portion 118 that cooperates with the end portion 108a at the maximum height H1 of the first retaining portion 102 to form a first corner retaining projection 120. The fourth retaining portion 116 includes an upper portion 122 that cooperates with the end portion 108b at the maximum height H1 of the first retaining portion 102 to form a second corner retaining projection 124.

The dispenser 7 further includes a cutout 132 formed in the second side panel 40. The cutout 132 includes an edge 134 that generally corresponds in shape with the fourth portion 99 of the tear line 89. The edge 134 defines a fifth retaining portion 136 that corresponds in shape with the fourth retaining portion 116. When the blank 3 is formed into the carton 5, the second side panel 40 overlies the side flap 50 to form a composite side panel that comprises a side panel portion and a side flap portion. Further, the cutout 132 lines up with the fourth portion 99 and the fifth retaining portion 136 overlies the fourth retaining portion 116 so that when the dispenser panel 87 is removed, the fourth and fifth retaining portions 116, 136 allow access to the containers C in the carton 5 through the composite second side panel 40/50.

In the illustrated embodiment, the dispenser 7 is opened by tearing the tear line 89 and removing the dispenser panel 87. The dispenser 7 may be otherwise sized, shaped, and/or located in the carton 5 without departing from the scope of this disclosure. For example, the first and second portions 93, 95 might extend in the back panel 30 between the fold lines 31, 41, the third portion 97 might extend in the second side panel 40, and the fourth portion might extend in the first side panel 20. Further, the dispenser 7 may be omitted from the carton 5 without departing from the scope of the disclosure.

The access feature 9 includes an access flap 142 in the first side panel 20. The access flap 142 is at least partially separable from the carton 5 along an access tear line 144 having two oblique portions 146a, 146b extending from the longitudinal fold line 62 and a semi-circular portion 146c extending between portions 146a, 146b. An access finger panel 148 is defined in the access flap 142 at least by the semi-circular portion 146c and an access fold line 150. The access feature 9 can be configured in any of the panels, and it can be spaced from the top of the carton 5 without departing from the scope of the disclosure. Further, the access feature 9 may be omitted from the carton 5 without departing from the scope of the disclosure.

In accordance with the exemplary embodiment, the carton blank 3 can be erected into the carton 5 by folding along fold lines 21, 31, 41, and 52 and adhering the side flap 50 to the second side panel 40. The second side panel 40 and the side flap 50 are adhered in face-to-face contact to form the composite second side panel 40/50, and the side flap 50 overlies the second side panel 40 so that the portion 99 lines up with the edge 134 and the fourth retaining portion overlies the fifth retaining portion 136. The carton blank 3 may be otherwise configured to have multiple front panels, multiple back panels, multiple side panels, or combinations thereof without departing from the scope of this disclosure.

In the illustrated embodiment, the first end 51 of the carton 5 is closed by respectively overlapping and adhering the side end flaps 22, 42 and the front and back end flaps 12, 32. The second end 53 of the carton 5 is closed by respectively overlapping and adhering the side end flaps 24, 44 and front and back end flaps 14, 34. Once the blank 3 is formed into a sleeve, the containers C may be loaded in the carton 5 from the first end 51 and then the first end may be closed by overlapping and gluing the side end flaps 22, 42 and front and back end flaps 12, 32, and then the second end 53 may be closed by overlapping and gluing the side end flaps 24, 44 and front and back end flaps 14, 34. The assembled carton 5 is shown in FIG. 2. Alternative assembling, loading, and closing steps may be used without departing from the scope of this disclosure.

Generally, the carton 5 is filled with containers C, such as cans for example, to form a package. Generally, the containers C are contained in the package for shipping to a point-of-sale vendor (e.g., grocery store) where the package can be converted to a display unit for displaying and dispensing the containers to consumers. The package is reloadable to provide a vertical, container shipper/self-ready dispenser.

As shown in FIG. 3, the carton 5 can be opened by actuating the dispenser 7 to create a dispenser opening 271 in the front panel 10 of the carton. The dispenser 7 is opened by pressing on the dispenser panel 87, tearing the carton along the tear line 89, and removing the dispenser panel 87 from the carton. Pressing on a portion of the dispenser panel 87 in the first side panel 20 or the side flap 50 can facilitate opening the dispenser 7. In an alternative embodiment, a portion of at least one of the portions 93, 95, 97, 99 of the tear line 89 can include a fold line so that the dispenser panel 87 folds open and remains attached to the remainder of the carton 5 upon activation. Other opening arrangements for the dispenser 7 can be provided.

In the illustrated embodiment, as shown in FIG. 3, the end portions 108a, 108b of the first retaining portion 102 retain at least one bottom-most container C at the intermediate height H3 while the central portion 106 provides access for viewing at least one of the bottom-most containers C at the minimum height H2. The central portion 106 also provides access for grasping the bottom-most containers C when the upper containers are removed. In the illustrated embodiment, the first retaining portion 102 retains one row of the bottom-most containers C; however, the first retaining portion 102 can retain any number of rows or no rows of containers C without departing from the scope of the disclosure.

The first and second corner retaining projections 120, 124 retain the next-to-be-dispensed container C at the maximum height H1, while the end portions 108a, 108b, 112a, 112b at respective heights H3 and H4 provide access for viewing and grasping the next-to-be-dispensed container C. The central portions 106, 110 at respective heights H2, H5 provide additional access for grasping the next-to-be-dispensed container C. Further, the third, fourth, and fifth portions 114, 116, 136 provide additional access for viewing and grasping the next-to-be-dispensed container C from the sides of the carton 5 at the intermediate height H3.

The second retaining portion 104 retains any containers above the next-to-be-dispensed container C. The central portion 110 provides access for viewing at least one container immediately above the next-to-be-dispensed container C, if any remain in the carton 5. After a container C is removed through the dispenser opening 271, an upper container is gravity-fed to the dispenser 7 so that a new container C is retained by the first and second corner retaining projections 120, 124.

As shown in FIG. 4, the access feature 9 can be activated by pressing the access finger panel 148 to bend the access flap 142 along the access fold line 150 and tear the access tear line 144 at the portion 146c. The access flap 142 can then be pulled outward to tear along portions 146a, 146b of the tear line 144 and fold the access flap 142 about the fold line 62 to create an access opening 281 in the side of the carton 5. The access opening 281 provides access to the interior of the top of the carton so that additional containers C can be added to the carton 5 as desired to replace containers that have been dispensed. In an alternative embodiment, the access feature 9 can be spaced from the top of the carton 5 and the access flap 142 can be folded about a fold line extending between the portions 146a, 146c of the access tear line 144.

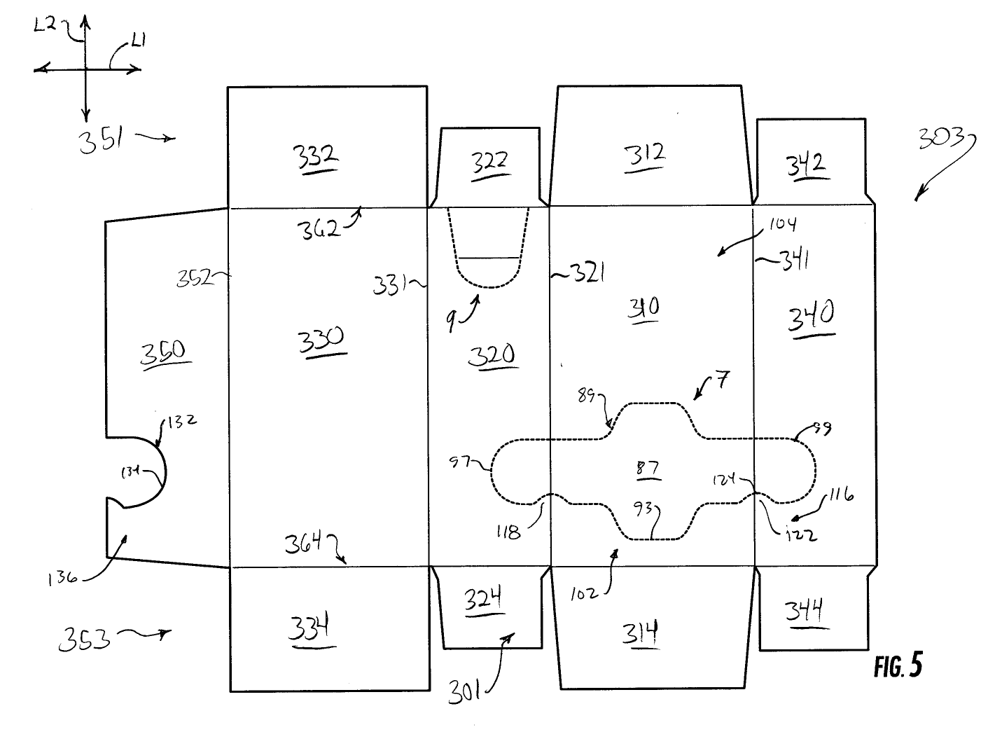

FIG. 5 is a plan view of the exterior side 301 of a blank, generally indicated at 303, used to form a carton according to a second embodiment of the disclosure. The second embodiment carton is configured similarly to carton 5 (FIG. 2) and includes the dispenser 7 and the access feature 9.

The carton blank 303 has a longitudinal axis L1 and a lateral axis L2. In the second embodiment, the blank 303 comprises a front panel 310 foldably connected to a first side panel 320 at a first lateral fold line 321. A back panel 330 is foldably connected to the first side panel 320 at a second lateral fold line 331. A second side panel 340 is foldably connected to the front panel 310 at a third lateral fold line 341. In the second embodiment, the blank 303 includes a side flap 350 foldably connected to the back panel 330 at a fourth lateral fold line 352. In the second embodiment, the fourth portion 99 of the tear line 89 of the dispenser is in the second side panel 340, and the cutout 132 is in the side flap 350. Further, the fourth retaining portion 110 is in the second side panel 340, and the fifth retaining portion 136 is in the side flap 350.

The front panel 310 is foldably connected to a first front end flap 312 and a second front end flap 314. The first side panel 320 is foldably connected to a first side end flap 322 and a second side end flap 324. The back panel 330 is foldably connected to a first back end flap 332 and a second back end flap 334. The second side panel 340 is foldably connected to a first side end flap 342 and a second side end flap 344. When the carton of the second embodiment is erected, the front and back end flaps 312 and 332 and side end flaps 322, 342 close a top end 351 of the carton, and the front and back end flaps 314 and 334 and side end flaps 324, 344 close a bottom end 353 of the carton. In accordance with an alternative embodiment of the present disclosure, different flap arrangements can be used for at least partially closing the ends 351, 353.

The front and back end flaps 312, 332 and side end flaps 322, 342 extend along a first marginal area of the blank 303, and are foldably connected at a first longitudinal fold line 362 that extends along the length of the blank. The front and back end flaps 14, 34 and side end flaps 324, 344 extend along a second marginal area of the blank 303, and are foldably connected at a second longitudinal fold line 364 that also extends along the length of the blank. The longitudinal fold lines 362, 364 may be, for example, substantially straight, or offset at one or more locations to account for blank thickness or for other factors.

The carton blank 303 can be erected into a carton by folding along fold lines 321, 331, 341, and 352 and adhering the side flap 350 to the second side panel 340. The side panel 340 and the side flap 350 are adhered in face-to-face contact to form the composite second side panel 340/350, and the side panel 340 overlies the side flap 350 so that the cutout 132 lines up with the portion of the dispenser 7 in the side panel 340. The carton blank 303 may be otherwise configured to have multiple front panels, multiple back panels, multiple side panels, or combinations thereof without departing from the scope of this disclosure.

The second embodiment carton formed from the blank 303 looks and operates in generally the same manner as the carton 5 of the first embodiment to hold, dispense, and restock the containers C.

The blanks according to the present disclosure can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blank. The blanks may also be coated with, for example, a moisture barrier layer, on either or both sides of the blank. In accordance with the above-described embodiments, the blanks may be constructed of paperboard of a caliper such that it is heavier and more rigid than ordinary paper. The blanks can also be constructed of other materials, such as cardboard, hard paper, or any other material having properties suitable for enabling the carton to function at least generally as described herein. The blanks can also be laminated or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments that are within the scope of the claims. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A carton for containing a plurality of articles, the carton comprising:
a plurality of panels that extends at least partially around an interior of the carton, the plurality of panels comprises a front panel, a back panel, a first side panel, and a second side panel;
a dispenser for allowing access to the articles to be contained in the carton, the dispenser comprising a dispenser panel that is at least partially defined by a tear line in the carton and is for being at least partially removed for at least further opening a dispenser opening, the tear line extending across at least a portion of at least one of the front panel and the back panel, the tear line defining at least one retaining portion in the at least one of the front panel and the back panel, wherein the at least one retaining portion is for at least partially retaining an article in the carton after the dispenser panel is removed; and
an access feature for allowing restocking of the articles to be contained in the carton, the access feature comprising an opening in at least one of the plurality of panels.

2. The carton of claim 1 wherein the retaining portion is a first retaining portion below the dispenser opening, and the carton further comprises a second retaining portion above the dispenser opening.

3. The carton of claim 2 wherein the tear line comprises a first portion defining the first retaining portion and a second portion defining the second retaining portion.

4. The carton of claim 3 wherein the first retaining portion is generally U-shaped having a central portion and two end portions at respective ends of the central portion, the two end portions having a maximum height of the first retaining portion and the central portion having a minimum height of the first retaining portion.

5. The carton of claim 4 wherein the tear line comprises a third portion extending from and connecting the first and second portions, the third portion being in one of the first side panel and the second side panel.

6. The carton of claim 5 wherein the tear line comprises a fourth portion extending from and connecting the first and second portions, the fourth portion being in the other of the first side panel and the second side panel.

7. The carton of claim 6 wherein the third portion of the tear line forms a third retaining portion in the at least one of the first side panel and the second side panel, the third retaining portion having an upper portion that is adjacent to and cooperates with one of the end portions of the first retaining portion to form a first corner retaining projection at a respective corner of the carton.

8. The carton of claim 7 wherein the fourth portion of the tear line forms a fourth retaining portion in the other of the first side panel and the second side panel, the fourth retaining portion having an upper portion that is adjacent to and cooperates with the other one of the end portions of the first retaining portion to form a second corner retaining projection at a respective corner of the carton.

9. The carton of claim 4 wherein each of the two end portions further comprise an intermediate height of the first retaining portion.

10. The carton of claim 3 wherein the second retaining portion has a central portion and two end portions at respective ends of the central portion, the two end portions having a maximum height of the second retaining portion and the central portion having a minimum height of the second retaining portion.

11. The carton of claim 1 wherein the access features comprise an access flap foldably connected to one of the first side panel and the second side panel.

12. The carton of claim 11 further comprising at least one end flap foldably attached to a panel of the plurality of panels, wherein the at least one end flap at least partially forms a closed end of the carton.

13. The carton of claim 12 wherein the at least one end flap comprises a first plurality of end flaps respectively foldably connected to the panels of the plurality of panels to close a first, top end of the carton, the access flap is adjacent the top end.

14. The carton of claim 13 wherein the at least one end flap comprises a second plurality of end flaps respectively foldably connected to the panels of the plurality of panels to close a second, bottom end of the carton, the dispenser panel is located adjacent to and spaced apart from the bottom end.

15. The carton of claim 1 wherein the second side panel comprises a side panel foldably connected to the back panel and a side flap foldably connected to the front panel, the side panel and the side flap being in face-to-face contact.

16. The carton of claim 15 wherein the dispenser opening comprises a cutout in the side panel and the dispenser panel comprises a portion of the side flap, the cutout and the portion of the side flap being in an overlapping relationship.

17. The carton of claim 1 wherein the second side panel comprises a side panel foldably connected to the front panel and a side flap foldably connected to the back panel, the side panel and the side flap being in face-to-face contact.

18. A carton blank for forming a carton, the carton blank comprising:
a plurality of panels comprising a front panel, a back panel, a first side panel, and a second side panel;
a dispenser for allowing access to a plurality of articles to be contained in the carton formed from the blank, the dispenser comprising a dispenser panel that is at least partially defined by a tear line in the blank and is for being at least partially removed for at least further opening a dispenser opening, the tear line extending across at least a portion of at least one of the front panel and the back panel, the tear line defining at least one retaining portion in the at least one of the front panel and the back panel, wherein the at least one retaining portion is for at least partially retaining an article in the carton formed from the blank after the dispenser panel is removed; and
an access feature for allowing restocking of the articles to be contained in the carton formed from the blank, the access feature comprising an opening in at least one of the plurality of panels.

19. The carton blank of claim 18 wherein the retaining portion is a first retaining portion below the dispenser opening, and the carton further comprises a second retaining portion above the dispenser opening.

20. The carton blank of claim 19 wherein the tear line comprises a first portion defining the first retaining portion and a second portion defining the second retaining portion, the first retaining portion is generally U-shaped having a central portion and two end portions at respective ends of the central portion, the two end portions having a maximum height of the first retaining portion and the central portion having a minimum height of the first retaining portion.

21. The carton blank of claim 20 wherein the tear line comprises a third portion extending from and connecting the first and second portions, the third portion being in one of the first side panel and the second side panel, and a fourth portion extending from and connecting the first and second portions, the fourth portion being in another of the first side panel and the second side panel.

22. The carton blank of claim 21 wherein the third portion of the tear line forms a third retaining portion in the at least one of the first side panel and the second side panel, the third retaining portion having an upper portion that is adjacent to and cooperates with one of the end portions of the first retaining portion to form a first corner retaining projection at a first transverse fold line connecting the third retaining portion and the first retaining portion.

23. The carton blank of claim 22 wherein the fourth portion of the tear line forms a fourth retaining portion in another of the first side panel and the second side panel, the fourth retaining portion having an upper portion that is adjacent to and cooperates with the other one of the end portions of the first retaining portion to form a second corner retaining projection at a second transverse fold line connecting the fourth retaining portion and the first retaining portion.

24. The carton blank of claim 18 wherein the access features comprise an access flap foldably connected to one of the first side panel and the second side panel.

25. The carton blank of claim 24 further comprising a first plurality of end flaps respectively foldably connected to the panels of the plurality of panels along a first marginal area of the blank for closing a first, top end of the carton formed from the blank, the access flap is adjacent the top end.

26. A method of forming a carton for containing a plurality of articles, comprising:
obtaining a carton blank comprising:
a plurality of panels comprising a front panel, a back panel, a first side panel, and a second side panel;
a dispenser for allowing access to the plurality of articles to be contained in the carton formed from the blank, the dispenser comprising a dispenser panel that is at least partially defined by a tear line in the blank and is for being at least partially removed for at least further opening a dispenser opening, the tear line extending across at least a portion of at least one of the front panel and the back panel, the tear line defining at least one retaining portion in the at least one of the front panel and the back panel, wherein the at least one retaining portion is for at least partially retaining an article in the carton formed from the blank after the dispenser panel is removed; and
an access feature for allowing restocking of the articles to be contained in the carton formed from the blank, the access feature comprising an opening in at least one of the plurality of panels; and
folding the panels of the plurality of panels into a carton.

27. The method of claim 26 wherein:
the tear line comprises a first portion defining the first retaining portion and a second portion defining a second retaining portion above the dispenser;
the first retaining portion is generally U-shaped having a central portion and two end portions at respective ends of the central portion, the two end portions having a maximum height of the first retaining portion and the central portion having a minimum height of the first retaining portion; and
the tear line comprises a third portion extending from and connecting the first and second portions, the third portion being in one of the first side panel and the second side panel.

28. The method of claim 26 wherein:
the second side panel comprises a side flap portion connected to one of the front panel and the back panel and a side panel portion connected to the other one of the front panel and the back panel, the side panel portion and the side flap portion are placed in face-to-face contact when folding the panels of the plurality of panels into a carton; and
the dispenser opening comprises a cutout in the side panel portion and the dispenser panel comprises a portion of the side flap portion, the cutout and the portion of the side flap portion for being placed in an overlapping relationship in the carton formed from the blank.

29. The method of claim 26 further comprising at least partially removing the dispenser panel by tearing along the tear line.

30. The method of claim 26 further comprising opening the access feature, wherein the access feature comprises an access flap foldably connected to one of the first side panel and the second side panel, and opening the access feature comprises folding the access flap outward from the one of the first and second side panels.

31. The method of claim 30 further comprising loading articles into the carton through the access feature.
